(19) United States
(12) Patent Application Publication
(10) Pub. No.: US 2011/0032534 A1
(43) Pub. Date: Feb. 10, 2011

(54) SYSTEM AND A METHOD FOR BROADBAND INTERFEROMETRY

(75) Inventors: Yacov Malinovich, Kiyat Tivon (IL); Gilad Golan, Raananna (IL)

Correspondence Address: RECHES PATENTS, 211 North Union St., Suite 100, Alexandria, VA, 22314, US

(73) Assignee: Camtek LTD, Migdal Haemek (IL)

(21) Appl. No.: 12/780,961

(22) Filed: May 17, 2010

Related U.S. Application Data
(60) Provisional application No. 61/179,395, filed on May 19, 2009.

(51) Int. Cl. G01B 11/02

(52) U.S. Cl. 356/498

(57) ABSTRACT

A method and a system for determining a depth of a space, the system includes: a scanner for scanning, by a single broadband light beam, the structural element and the area of the surface of the object, wherein the area at least partially surrounds the structural element; a sensor for detecting interference patterns generated when the single broadband light beam concurrently illuminates a portion of the area and at least a portion of the structural element; and an analyzer for analyzing the interference patterns to determine the height difference between the area and the structural element.

### RELATED APPLICATIONS

This patent application claims priority from U.S. provisional application Ser. No. 61/179,395 filed on May 19, 2009 which is incorporated herein by reference.

### FIELD OF THE INVENTION

The invention relates to broadband interferometry of objects such as but not limited to wafers.

### BACKGROUND OF THE INVENTION

Interferometers split a beam of light to two beams, pass these two beams through different optical paths to introduce a phase shift between these two beams and then recombine them. Known interferometers are the Michelson interferometer and the Mirau interferometer.

The web site www.wikipedia.org provides the following description of these interferometers. The Michelson interferometer is the most common configuration for optical interferometry and was invented by Albert Abraham Michelson. An interference pattern is produced by splitting a beam of light into two paths, bouncing the beams back and recombining them. The different paths may be of different lengths or be composed of different materials to create alternating interference fringes on a back detector. There are two paths from the (light) source to the detector. One reflects off the semi-transparent mirror, goes to the top mirror and then reflects back, goes through the semi-transparent mirror, to the detector. The other first goes through the semi-transparent mirror, to the mirror on the right, reflects back to the semi-transparent mirror, then reflects from the semi-transparent mirror into the detector. The principle is when a parallel beam of light coming from a monochromatic extended light source is incident on a half silvered glass plate, it is divided into two beams of equal intensities by partial reflection and transmission. If these two paths differ by a whole number (including 0) of wavelengths, there is constructive interference and a strong signal at the detector. If they differ by a whole number and half wavelengths (e.g., 0.5, 1.5, 2.5 . . . ) there is destructive interference and a weak signal.

A Mirau interferometer works by the same principles as a Michelson interferometer. The difference between the two is in the physical location of the reference arm. The reference arm of a Mirau interferometer is located within a microscope objective assembly. A beam splitter following the lens splits the beam, with the sample arm proceeding forward to the sample, and the reference arm reflected backward into the objective assembly. This orientation is often used in optical profilometers due to the increase in stability between the sample and reference path lengths.

FIG. 1 illustrates two prior art Mirau interferometers 10 and 11. Each includes an objective lens 12 that is followed by a beam splitter 14. The objective lens 12 directs a light beam towards the beam splitter 14. The beam splitter 14 transfers some of the light beam towards the sample 20 but reflects some of the light beam towards a reflective reference surface 16. The reference surface 16 reflects that light beam towards the beam splitter 14. Mirau interferometer 10 has the reference surface 16 integrated with the objective lens 12. Mirau interferometer 11 has the reference surface 16 mounted on a support element 17 and positioned between the objective lens 12 and the beam splitter 14.

In both cases one light beam passes through the beam splitter 14 and impinges on the object 20 while the second light beam is reflected from the beam splitter towards the reference surface 16, reflected towards the beam splitter 14 and passes through the beam splitter 14 to impinge on the object 20.

When using a white light source, the obtained digital intensity signal in terms of the OPD (Optical Path Difference) is varied through focus. It resembles an amplitude modulated (AM) signal. The peak value can be extracted by first demodulating the signal and then performing peak detection of the envelope. Specialized digital signal processing hardware makes this process very efficient.

The mentioned above interferometers include dedicated optics for splitting and recombining the beam into two beams.

There is a growing need for methods and systems for broadband light interferometry in which there is no need to use external reference surface that assists in splitting the light beam, especially when the measuring system does not use a Mirau arrangement and instead uses glass plate on top of the object, as a glass plate on top of sensitive objects like Silicon wafer in process can damage the top delicate structures and prevent the option to use the described solution. It is also very difficult to get high quality glass plates with the required optical quality in the large dimensions of modern Silicon wafers.

### SUMMARY

A system for determining a height difference between an area of a surface of an object and a structural element, the system includes: (i) a scanner for scanning, by a single broadband light beam, the structural element the area of the surface of the object, wherein the area at least partially surrounds the structural element; (ii) a sensor for detecting interference patterns generated when the single broadband light beam concurrently illuminates a portion of the area and at least a portion of the structural element; and (iii) an analyzer for analyzing the interference patterns to determine the height difference between the area and the structural element.

The detector may be further configured to detect non-interference patterns generated when the single broadband light beam illuminates only a portion of the area.

The analyzer may be further configured to analyze the interference patterns and the non-interference patterns to determine a shape of the structural element.

The scanner may be prevented from introducing substantial phase shifts between beamlets of the single broadband light beam.

The structural element may be a space or a protuberance.

A method for determining a height difference between an area of a surface of an object and a structural element that is surrounded by the area. According to an embodiment of the invention the method may include: (i) scanning by a single broadband light beam, the structural element and the area; (ii) detecting interference patterns generated during the scanning, when the single broadband light beam concurrently illuminates a portion of the area and the structural element; (iii) detecting non-interference patterns generated when the single broadband light beam illuminates only a portion of the area; and (iv) analyzing the interference patterns to determine the height differences between the area and the extreme point.

The structural element may be a space that has an opening that is at least partially surrounded by the area. The method may include: (a) scanning by a single broadband light beam, the space and the area; (b) detecting interference patterns generated during the scanning, when the single broadband light beam concurrently illuminates the portion of the area and a bottom of the space; (c) detecting non-interference patterns generated when the single broadband light beam illuminates only the portion of the area; and (d) analyzing the interference patterns to determine a depth of the space.

The structural element may be a protuberance that is at least partially surrounded by the area. The method may include: (a) scanning by a single broadband light beam, the protuberance and the area; (b) detecting interference patterns generated during the scanning, when the single broadband light beam concurrently illuminates the portion of the area and a highest point of the protuberance; (c) detecting non-interference patterns generated when the single broadband light beam illuminates only the portion of the area; and (d) analyzing the interference patterns to determine a height of the highest point of the protuberance.

The method may include analyzing the interference patterns and the non-interference patterns to determine a shape of the structural element.

The single broadband light beam may be a white light beam.

The single broadband light beam may be an infra red light beam.

The method may include generating the single broadband light beam without introducing substantial phase shifts between beamlets of the single broadband light beam.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates two prior art Mirau interferometers;

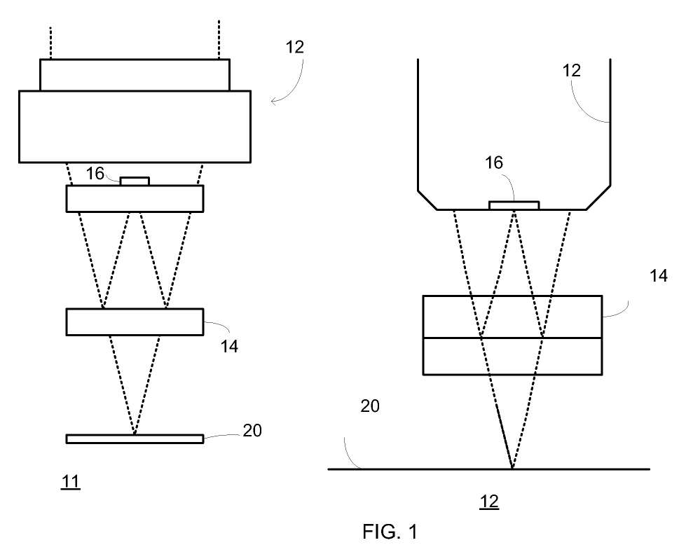

FIGS. 2a-2e illustrate an interaction of a single broadband light beam with a surface of an object and with a space formed in the object, according to an embodiment of the invention;

FIGS. 3a-3e illustrate an interaction of a single broadband light beam with a surface of an object and with a protuberance that is higher than the surface, according to an embodiment of the invention;

FIG. 4 illustrates a scanning pattern of a single broadband light beam according to an embodiment of the invention;

FIG. 5 illustrates a system and an object according to an embodiment of the invention; and

FIG. 6 is a flow chart of method according to an embodiment of the invention.

### DETAILED DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It is noted that herein disclosed invention relates to systems and methods for broadband interferometry (such as white light interferometry), and without an optical reference (and/or without external reference surface).

It will be noted that herein disclosed systems and methods enable to use white light interferometry for three dimensional (3D) measurements without external reference like glass plate on the top of the object.

The new methods and systems used for 3D measurements of structural element (like a blind via or a bump) in an object (like a Silicon wafer) that has a reflective surface. In the disclosed methods and systems there is no external reference surface inside the objective or between the objective and the object or in any other place in the optical path.

A measurement of a depth of a space or a of a height of a protuberance (generally referred to as a height difference measurement) may be done while the object is scanned (horizontally) by a single broadband light beam while introducing motion along a line of the object or the objective lens.

The diameter of the single broadband light beam may be relatively large compared to the measured structural element, but this is not necessarily so.

According to another embodiment of the invention the diameter of the single broadband light beam is not larger than the width of the structural element but wide enough to impinge on both the surface of the object and on the structural element, when directed substantially to the edge of the structural element.

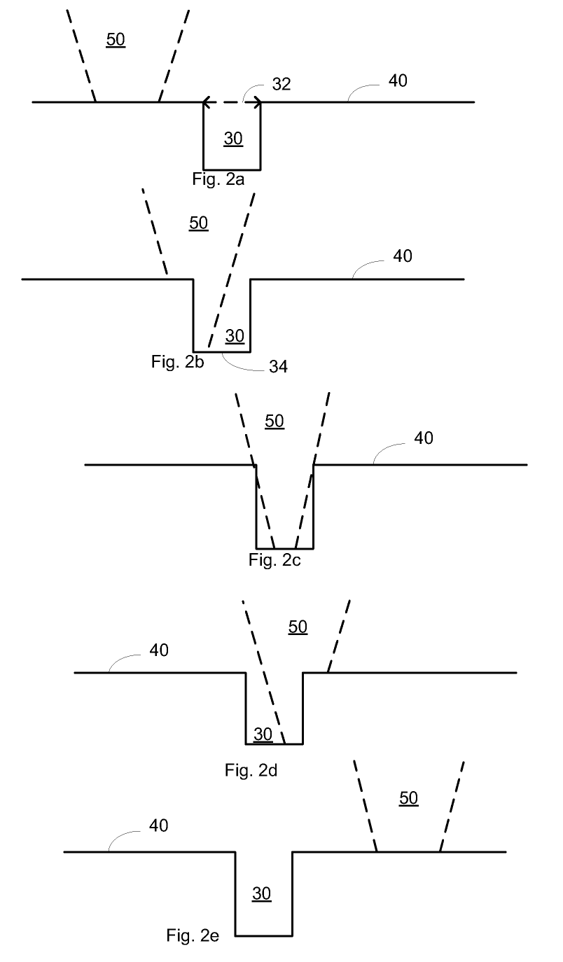

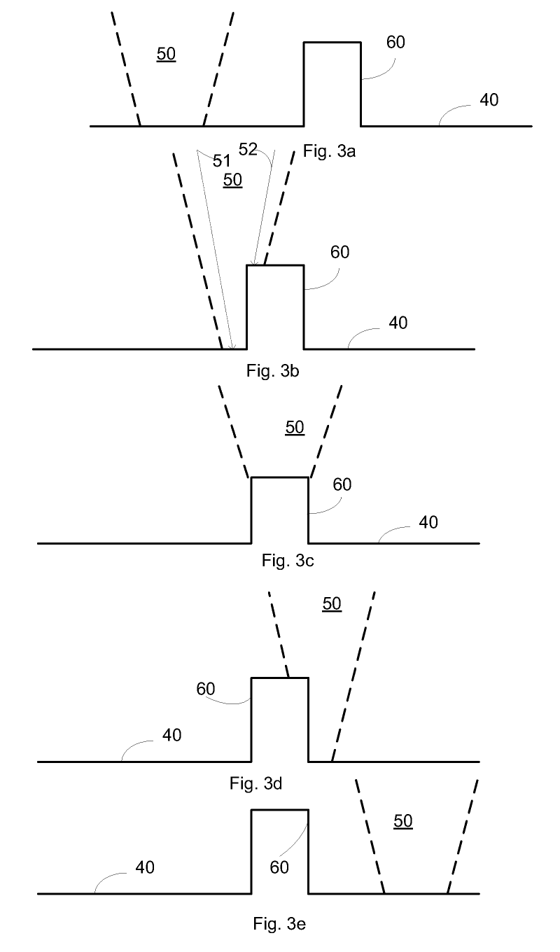

When scanning a structural element and an area that at least partially surrounds it, there will be measurement points (near the edge of the structural element) in which the broadband light beam will cover both the object surface and the structure surface—as illustrated in FIGS. 2b, 2d, 3b and 3d.

In these measurement points part of the single broadband light beam may be reflected from a reflective surface of the object (for example—from a surface of a Silicon wafer) and part of the single broadband light beam will be reflected from the structural element (e.g. from the bottom of space 30 via or from a top of a protuberance 60). Space 30 has an opening 32.

FIG. 3b illustrates two beamlets 51 and 52 of the single broadband light beam 50—beamlet 52 impinges on the surface 40 while beamlet 52 impinges on the top of protuberance 60. The difference in heights between surface 40 and protuberance 60 introduces an optical path differences between the beamlets and therefore phase difference between these beamlets that generates an interference pattern.

There may be measurement points in which the single broadband light beam impinges only on the structural element as illustrated in FIGS. 2c and 3c.

Such measurement points may exit if the beam cross section is smaller (or at least one larger) than an opening of an illuminated space (as illustrated in FIG. 2c) or an area of the protuberance (as illustrated in FIG. 3c).

There are also measurements points in which the broadband light beam illuminates only the surface of the object—as illustrated in FIGS. 2a, 2e, 3a and 3e.

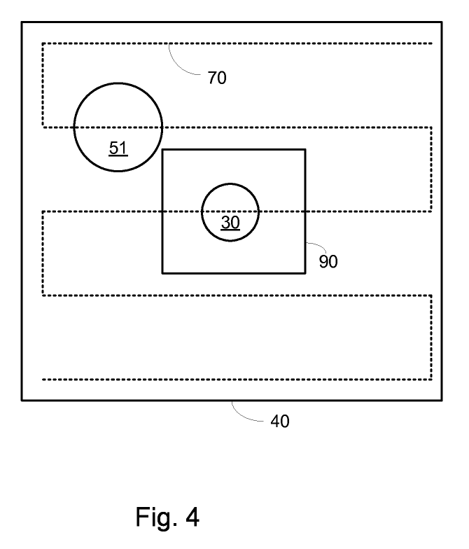

FIG. 4 illustrates a raster scan pattern (dashed lines 70) of a surface 40 of an object 20. FIG. 4 illustrates a spot 51 formed by the broadband light beam 50 when it scans surface 40. An area 90 of the surface 40 is also scanned during the raster scan. The area 90 surrounds the opening 32 of space 30.

It is noted that according to different embodiments of the invention, the single broadband light beam 50 may be by a white light beam, a wide spectrum infra-red (IR) beam, a beam of both white light and IR illumination, and so forth.

A sensor (e.g. optical detector, camera) will get interference patterns created according to the height difference between the structural element and the surface. Accordingly, system 200 will calculate the difference in the optical path in the same way it is done in a standard white light interferometer (with external reference). In measurement points where the white light beam illuminates only a single type of surface there will be no interference image on the camera.

Referring, for example, to FIGS. 2a-2e, 2a-3e and 4, by scanning the surface 40 of object 20 as well as a space such as space 30 or a protuberance such as protuberance 60, different types of detection signals may be obtained—some detection signals will reflect non-interference patterns (when only surface 40 is illuminated) and some detection signals will reflect interference patterns. These interference patterns will differ from each other as a function of the height differences between the surface and the structural elements. Using spectral analysis of the interference patterns with its peaks and valleys signals enables to match the signals to known height differences and the system will analyze the interference patterns to extract the height differences.

It is noted that in the disclosed systems and methods, there is no need to use any external reference surface, the interference is a results of light reflections only from the object.

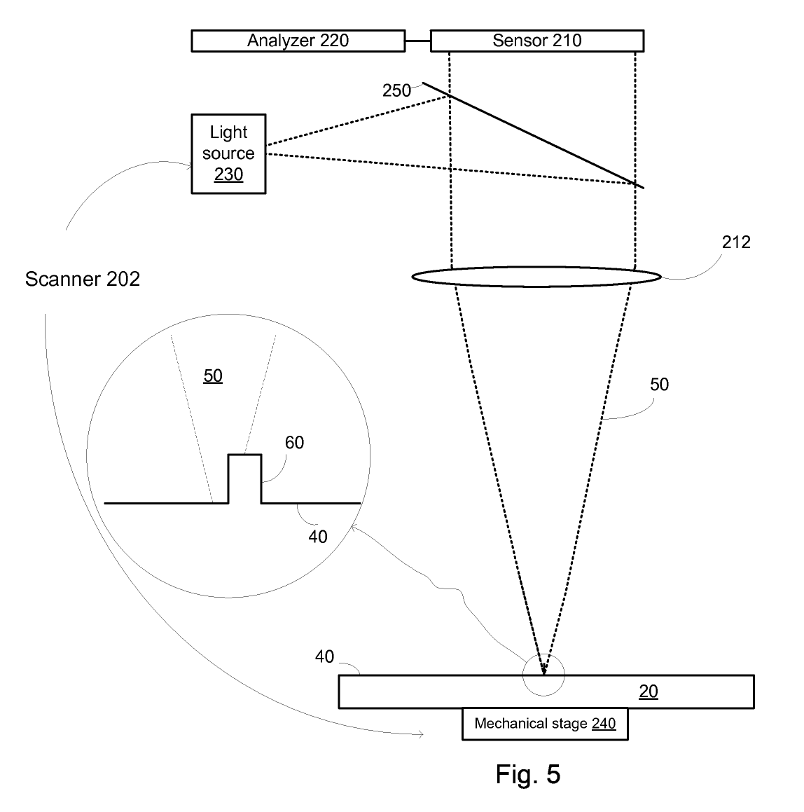

FIG. 5 illustrates a system 200, according to an embodiment of the invention.

FIG. 5 illustrates a bright field configuration in which the object 20 is illuminated at a normal angle. It is noted that system 200 may apply dark field illumination or other types of illumination and, additionally bright field collection or other types of collection.

System 200 includes a scanner 202, a sensor 210, an objective lens 212, a beam splitter 250, an illumination unit such as light source 230 and analyzer 220.

Scanner 202 is illustrated as including light source 230 and mechanical stage 240. It is noted that the scanning may include movement introduced by the mechanical stage 240, mechanical, electrical or optical deflection of the single broadband light beam or a combination thereof.

Sensor 210 is adapted to detect broadband light and its spectral structure that is reflected from object 20, wherein object 20 includes a reflective surface 40 and at least one structural element (such as protuberance 60).

Detection spectral signals generated by sensor 210 are processed by processor 220 that may determine the height difference between surface 40 and protuberance 60.

It is noted that conveniently, the broadband (wide-spectrum) light that is reflected from object 20 (after being illuminated by a wide-spectrum illumination) may be white light, but that different wide portion of the electromagnetic spectrum may be implemented in different embodiments of the invention (this is also correct to other places in the disclosure in which white light is referred).

Conveniently, system 200 further includes a broadband (wide-spectrum) illumination unit 230, for illuminating a portion of object 20 with wide-spectrum illumination. It is however noted that the light source 230 may also be external to system 200.

It is noted that according to an embodiment of the invention, light source 230 is capable to illuminate object 20 (and/or sensor 210 is adapted to acquire light reflected from object 20) while object 20 is scanned horizontally by motion along a line of the object 20 or the objective 212.

According to an embodiment of the invention, object 20 is illuminated with a single broadband light beam whose diameter (measured at an interaction between the single broadband light beam and the object 20) should is sufficiently large compared to the structural element, so that there will be measurement points in which the wide-spectrum illumination beam will cover both a portion of reflective surface 20 and at least a portion of a structure element (such as space 30 or protuberance 60). The diameter (or the cross section) of the single broadband light beam 50 may be wide enough to allow part of the single broadband light beam to be reflected from the object 20 and part of the single broadband light beam 50 to be reflected from the structural element (e.g. from the bottom of the via or the top of a protuberance) when directed substantially to the edge of the structural element.

When such a measurement point is so illuminated, sensor 210 gets the interference signal created according to the length of the optical path between the two surfaces. Accordingly, analyzer 220 is configured to calculate a deference in an optical path (e.g. similarly to the way it is done in a standard white light interferometer with external reference) between beamlets of the single broadband light beam that impinges concurrently on the surface 40 and on the structural element. In measurement points where the white light beam illuminates only a single type of surface there will be no interference image (a non-interference pattern) on the sensor 210.

It is noted that, according to an embodiment of the invention, system 200 may include multiple sensors 210 that may and may not operate at least partly concurrently, for covering wider areas of object 20. It is noted that the multiple sensors 210 may require, according to different embodiments of the invention, one or more additional illumination units 230, one or more additional analyzers, and possibly other components as well, facilitates more efficient and/or faster coverage of wider areas.

According to an embodiment of the invention the system scans the object by multiple broadband light beams that are spaced apart from each other such as not to cause interactions or interferences between the different broadband light beams.

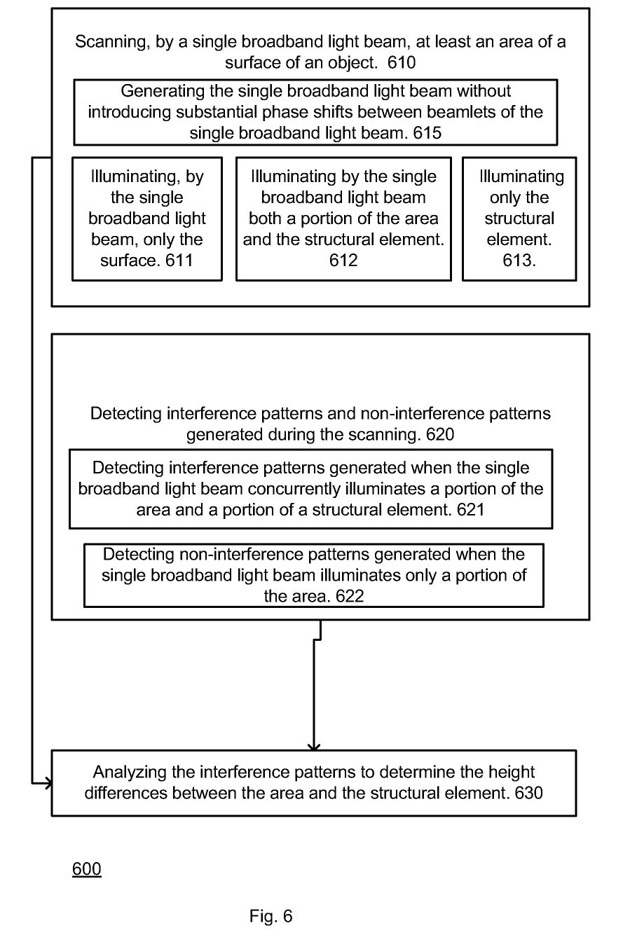

FIG. 6 illustrates method 600 for determining a height difference between an area of a surface of an object and an extreme point of a structural element that is surrounded by the area, according to an embodiment of the invention.

FIG. 600 starts by stages 610 and 620.

Stage 610 includes scanning, by a single broadband light beam, at least an area of a surface of an object. The scanned area may include one or more structural elements that have a height (or depth) that differs from the height of the area. The area is expected to be flat but this is not necessarily so and small variations (or small inclination) of the area may exist. In such a case the height of the area may be an average height of the area or be a result of applying any other statistical function on heights of the area. Referring to the example set fourth in FIG. 4, the area 90 can be a portion of the surface of the object 40 and may surround a structural element such as hole 30.

Accordingly, the scanning may include illuminating, by the single broadband light beam, only the surface (as illustrated in FIGS. 2a and 2d), concurrently illuminating, by the single broadband light beam both a portion of the area and the hole 30 (as illustrated in FIGS. 2b and 2d) and even illuminating only the structural element (as illustrated in FIG. 2c). The same may apply when illuminating a protuberance such as protuberance 60 as illustrated by FIGS. 3a-3e.

The manner in which the single broadband light beam illuminates the object 20 is illustrated by: (i) stage 611 of illuminating, by the single broadband light beam, only the surface, (ii) stage 612 of illuminating by the single broadband light beam both a portion of the area and the structural element and (iii) stage 613 of illuminating only the structural element. It is noted that broader single broadband light beams may provide interference patterns during a longer period than narrower single broadband light beams.

Stage 610 may also include stage 615 of generating the single broadband light beam without introducing substantial phase shifts between beamlets of the single broadband light beam.

Stage 620 includes detecting interference patterns and non-interference patterns generated during the scanning.

Stage 620 includes stage 621 of detecting interference patterns generated when the single broadband light beam concurrently illuminates a portion of the area and a portion of a structural element. The portion of the structural element may be an extreme point such as a bottom of a hole (such as bottom 34 of hole 30 of FIG. 2b), or a highest point of a protuberance.

Stage 620 includes stage 622 of detecting non-interference patterns generated when the single broadband light beam illuminates only a portion of the area.

Stage 620 may also include detecting signals when the single broadband light beam illuminates only the structural element.

Stage 610 and 620 are followed by stage 630 of analyzing the interference patterns to determine the height differences between the area and the structural element. Stage 630 may include determining the height difference between the area and an extreme point (highest point of a protuberance or a lowest point of a space) of the structural element. Due to the size of the single broadband light beam an averaging effect may occur and the height difference may reflect the difference between multiple points of the area and multiple points of the structural element.

The structural element may be a space that has an opening that is surrounded by the area. In this case stage 610 may include scanning by a single broadband light beam, the area, the space and concurrently illuminating a portion of the area and at least a portion of the space. Stage 621 may include detecting interference patterns generated during the scanning, when the single broadband light beam concurrently illuminates the portion of the area and a bottom of the space. Stage 630 may include analyzing the interference patterns to determine a depth of the space.

The structural element may be a protuberance that is surrounded by the area. In this case stage 610 may include scanning by a single broadband light beam, the protuberance, the area and concurrently scanning the area and the protuberance. Stage 612 may include detecting interference patterns generated during the scanning, when the single broadband light beam concurrently illuminates the portion of the area and the protuberance.

Stage 630 may include analyzing the interference patterns to determine a height of the protuberance.

Stage 630 may include stage 634 of analyzing the interference patterns and the non-interference patterns to determine a shape of the structural element. Thus, the shape may be determined by locating the edges of the structural element as an edge of the structural element one illuminated may initiate a detection of interference patterns.

According to an embodiment of the invention the method 600 includes scanning the object by multiple broadband light beams that are spaced apart from each other such as not to cause interactions or interferences between the different broadband light beams.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for determining a height difference between an area of a surface of an object and a structural element, the system comprises:
a scanner for scanning, by a single broadband light beam, the structural element and the area of the surface of the object, wherein the area at least partially surrounds the structural element;
a sensor for detecting interference patterns generated when the single broadband light beam concurrently illuminates a portion of the area and at least a portion of the structural element; and
an analyzer for analyzing the interference patterns to determine the height difference between the area and the structural element.

2. The system according to claim 1 wherein the detector is further configured to detect non-interference patterns generated when the single broadband light beam illuminates only a portion of the area.

3. The system according to claim 2, wherein the analyzer is further configured to analyze the interference patterns and the non-interference patterns to determine a shape of the structural element.

4. The system according to claim 1, wherein the single broadband light beam is a white light beam.

5. The system according to claim 1, wherein the single broadband light beam is an infra red light beam.

6. The system according to claim 1, wherein the scanner is prevented from introducing substantial phase shifts between beamlets of the single broadband light beam.

7. The system according to claim 1 wherein the structural element is a space and wherein the analyzer is configured to determine a depth of the space.

8. The system according to claim 1 wherein the structural element is a space that has an opening surrounded by the area and wherein the analyzer is configured to determine a shape of the opening.

9. The system according to claim 1 wherein the structural element is a protuberance and wherein the analyzer is configured to determine a height of the protuberance.

10. The system according to claim 1 wherein the structural element is a protuberance and wherein the analyzer is configured to determine a shape of the protuberance.

11. A method for determining a height difference between an area of a surface of an object and a structural element that is surrounded by the area, the method comprises:
scanning by a single broadband light beam, the structural element and the area;
detecting interference patterns generated during the scanning, when the single broadband light beam concurrently illuminates a portion of the area and at least part of the structural element;
detecting non-interference patterns generated when the single broadband light beam illuminates only a portion of the area; and
analyzing the interference patterns to determine the height differences between the area and the structural element.

12. The method according to claim 11, wherein the structural element is a space that has an opening that is surrounded by the area; wherein the method comprises:
scanning by a single broadband light beam, the space and the area;
detecting interference patterns generated during the scanning, when the single broadband light beam concurrently illuminates the portion of the area and a bottom of the space;
detecting non-interference patterns generated when the single broadband light beam illuminates only the portion of the area; and
analyzing the interference patterns to determine a depth of the space.

13. The method according to claim 11, wherein the structural element is a protuberance that is surrounded by the area; wherein the method comprises:
scanning by a single broadband light beam, the protuberance and the area;
detecting interference patterns generated during the scanning, when the single broadband light beam concurrently illuminates the portion of the area and the protuberance;
detecting non-interference patterns generated when the single broadband light beam illuminates only the portion of the area; and
analyzing the interference patterns to determine a height of the protuberance.

14. The method according to claim 11, further comprising analyzing the interference patterns and the non-interference patterns to determine a shape of the structural element.

15. The method according to claim 11, wherein the single broadband light beam is a white light beam.

16. The method according to claim 11, wherein the single broadband light beam is an infra red light beam.

17. The method according to claim 11, comprising generating the single broadband light beam without introducing substantial phase shifts between beamlets of the single broadband light beam.
